(19) United States
(12) Patent Application Publication
(10) Pub. No.: US 2012/0254002 A1
(43) Pub. Date: Oct. 4, 2012

(54) CENTRALIZED FINANCIAL MANAGEMENT TOOL AND METHOD OF USE

(75) Inventors: Chandramouli Kundagrami, Bangalore (IN); Arunnima Balakrishnan Senakumari, Kerala (IN)

(73) Assignee: INFOSYS TECHNOLOGIES, LTD., Bangalore (IN)

(21) Appl. No.: 13/217,344

(22) Filed: Aug. 25, 2011

(30) Foreign Application Priority Data
Mar. 31, 2011 (IN) 1070/CHE/2011

(51) Int. Cl. G06Q 40/02

(52) U.S. Cl. 705/35

(57) ABSTRACT

A system and method of providing a centralized financial management tool which includes a financial application module implemented on a network device. The network device includes a linking interface which operates with the financial application module. The module, via the linking interface, sends requests in the form of messages compliant with a standardized messaging scheme, to receive account information of the user's different accounts from one or more different subscribed financial institutions. The module receives account information of the user's different accounts in the form of messages compliant with the standardized messaging scheme from the subscribed financial institutions. The module compiles and displays the account information for the user's different accounts in a user interface. The compiled account information can be categorized to allow the user to analyze, budget, and seek information from other users and financial advisors as well as perform any other financial management related functions on any of the user's different accounts.

This application claims the benefit of Indian Patent Application Filing No. 1070/CHE/2011, filed Mar. 31, 2011, which is hereby incorporated by reference in its entirety.

### FIELD

The present disclosure relates to a system and method for consumer based finance tools, and in particular, a centralized financial management tool and method of use.

### BACKGROUND

In today's environment, Internet Banking is commonplace. In particular, almost every financial institution has an Internet presence where a customer can access their account information and view their assets, liabilities, transaction histories as well as conduct financial transactions. In addition, most individuals employ and hold accounts at several financial institution, especially those that provide specialized services and products (e.g. car loans, home mortgages, retirement benefits, stock and/or mutual fund investments).

However, it is burdensome for the user to have to visit several different institution websites to conduct their business and manage their finances end to end. For example, the user must remember his/her login information for every financial institution where he/she want to access account information. Therefore, an unsophisticated user may use the same login and password information to access all his/her financial institutions' websites. This may be disastrous if that login and password is uncovered as all of the user's accounts may be compromised.

Present technology allows independent software vendors (ISV) to offer financial management services to the customer in the form of a centralized website. However, customers are required to register to the ISV's website and key in income/expenditure details. Alternatively, customers are required to provide their specific customer ID or login information for their financial institutions to enable the ISV to access their online banking accounts from the multiple financial institutions and display them. These types of systems suffer from similar security problems as they store the user's login/password information to access their accounts online. Therefore, infiltration of these ISV systems may be catastrophic to the user.

Several limitations exist in the current systems. In particular, the current systems do not provide a centralized financial management tool that allows different financial institutions to securely communicate users' account information with one another. Further, these system do not provide financial advice to the user based on specific information of the users' accounts.

It is important for a user to have a view of his/her complete financial position in order to plan his financial goals. It is not enough that the user gets a complete view of his/her holdings with the financial institutions. The user may have other assets like land, vehicle, gold, postal savings and other liabilities like cash borrowed from a friend etc, which may not be directly linked to the banking relationship. These assets should be easily controlled by the user through a centralized financial management tool.

What is needed is a centralized financial management tool and method of use which addresses these disadvantages.

### SUMMARY

In an aspect, a method of providing a centralized financial management tool which comprises executing a financial application module implemented on a network device. The network device includes a linking interface that is configured to operate with the financial application module. The method includes requesting first account information for a user from a first server of a subscribed first financial institution, wherein the request is communicated from the financial application module. The request is sent from the linking interface as one or more messages in compliance with a standardized messaging scheme. The method includes receiving the first account information at the linking interface of the network device. The first account information is transmitted from the first server of the subscribed first financial institution as one or more transmitted messages that are in compliance with the standardized messaging scheme. The method includes compiling the first account information from the first server; and displaying the compiled first account information in the use interface.

In an aspect, a non-transitory machine readable medium having stored thereon instructions for providing a centralized financial management tool, comprising machine executable code which when executed by at least one machine, causes the machine to execute a financial application module implemented on a network device. The network device includes a linking interface that is configured to operate with the financial application module and request first account information for a user from a first server of a subscribed first financial institution. The request is communicated from the financial application module, wherein the request is sent from the linking interface as one or more messages in compliance with a standardized messaging scheme. The machine configured to receive the first account information at the linking interface of the network device. The first account information is transmitted from the first server of the subscribed first financial institution as one or more transmitted messages in compliance with the standardized messaging scheme. The machine configured to compile the first account information from the first server; and display the compiled first account information in the user interface.

In an aspect, a computer system comprises a linking interface configured to allow communications between a server and a financial application module. The computer including a memory and a processor coupled to the linking interface and the memory. The processor operative to execute a financial application module implemented in the memory and request first account information for a user from a first server of a subscribed first financial institution. The request is communicated from the financial application module, wherein the request is sent from the linking interface as one or more messages in compliance with a standardized messaging scheme. The processor configured to receive the first account information at the linking interface. The first account information transmitted from the first server of the subscribed first financial institution as one or more transmitted messages in compliance with the standardized messaging scheme. The processor configured to compile the first account information from the first server; and display the compiled first account information in the user interface.

In one or more of the above aspects, a user instruction is received via the user interface to obtain second account information from a second server of a subscribed second financial institution. The financial application module requests the second account information via the linking interface of the first server to a corresponding linking interface of the second server as one or more messages in compliance with a standardized messaging scheme. The first server receives the second account information from the second server of the subscribed second financial institution as one or more transmitted messages in compliance with the standardized messaging scheme. The first server compiles the second account information and displays the compiled second account information in the use interface. The financial application module is able to receive account information from as many subscribed financial institutions where the user has an account. In or more of the above aspects, all account information from the subscribed financial institutions are continually updated to the financial application module.

The complied account information comprises at least transaction information that is categorizable by the user using the financial application module. The financial application module is configured to allow the user to view and categorize the compiled account and transaction information of the one or more accounts. The financial application module is also configured to allow the user to analyze, budget, and seek information from other users and financial advisors and, in general, perform any other financial management related function related to the accounts of subscribed financial institutions.

In one or more of the above aspect, the financial application module receives user authentication information when the user attempts to access the financial application module. In an aspect, the authentication information is unique to the financial application module and is different than user authentication information associated with accessing the second financial institution directly through a dedicated website of the second financial institution.

In one or more of the above aspects, the financial application module and the linking interface is within a server, wherein the server that is handled by a financial institution or another entity independent of any financial institution. In an aspect, the financial application module is accessed via a client device.

### BRIEF DESCRIPTION OF THE DRAWINGS

FIG. 1 illustrates a diagram of an example system environment that allows operation of a centralized financial application module in a network in accordance with an aspect of the present disclosure;

FIG. 2A illustrates a block diagram of a client device accessing at least a portion of the centralized financial application module in accordance with an aspect of the present disclosure;

FIG. 2B illustrate a block diagram of a server implementing at least a portion of the centralized financial application module in accordance with an aspect of the present disclosure;

FIG. 3 illustrates a block diagram of the financial application module implemented in a standalone network device in accordance with an aspect of the present disclosure;

FIG. 4 illustrates a block diagram of a plurality of financial institution core servers, at least one of which includes the financial application module implemented therein in accordance with an aspect of the present disclosure; and

FIG. 5 is an example flow chart diagram depicting portions of processes performed by at least the financial application module in accordance with the present disclosure.

### DETAILED DESCRIPTION

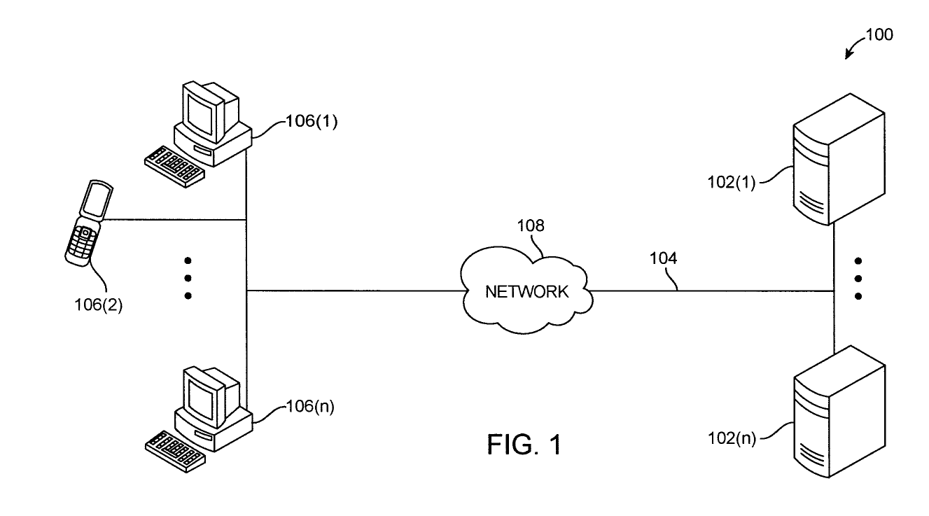

FIG. 1 illustrates a diagram of an example system environment that implements and executes the novel financial application module and method of the present disclosure. In particular, the example system environment 100 includes one or more servers 102(1)-102(n), at least one of which is handled and operated by a financial institution to store and manage user account information. As will be discussed below, the financial application module may be implemented in a server 102 that is not handled by a financial institution and/or a client device 106. It should be noted that the term “network devices” can be referred to as encompassing one or more client devices, one or more servers and/or other hardware components in the system 100.

The environment 100 includes one or more client devices 106(1)-106(n), although the environment 100 could include other numbers and types of devices in other arrangements. In an aspect, one or more of the servers 102(1)-102(n) are connected to a local area network (LAN) 104 and the client devices 106(1)-106(n) are connected to a wide area network 108, whereby the one or more client devices 106(1)-106(n) communicate with the one or more servers 102(1)-102(n) via the wide area network 108 and LAN 104. In another aspect, one or more servers 102(1)-102(n) connect to one another over the network 108. It should be noted that although the client device and/or server may be referred to herein in the plural, it is contemplated that only one client device and/or one server may be considered without being limiting to the language used herein. It should be understood that the particular configuration of the system 100 shown in FIG. 1 are provided for exemplary purposes only and is thus not limiting.

Client devices 106(1)-106(n) comprise computing devices capable of connecting to other computing devices, such as the servers 102(1)-102(n). Such connections are performed over wired and/or wireless networks, such as network 108, to send and receive data, such as for Web-based requests, receiving responses to requests and/or performing other tasks, in accordance with the novel processes described herein. Non-limiting and non-exhausting examples of such client devices 106(1)-106(n) include, but are not limited to, personal computers (e.g., desktops, laptops), mobile and/or smart phones, kiosks, ATMs, tablet devices, PDAs and the like.

In an example, client devices 106(1)-106(n) may be configured to run a Web browser that provides a user interface for human users to interact with, request resources and/or information, as well as submit instructions over the network 108 to the one or more servers 102(1)-102(n) via Web-based or non Web-based applications. One or more Web-based or non Web-based applications may accordingly run on the servers 102(1)-102(n) that provide the requested data to the client device 106(1)-106(n) and/or perform the requested instructions on behalf of the user. In an example, the client device 106 may be a smart phone, tablet, or smart television in which the client devices 106(1)-106(n) communicate with the servers 102(1)-102(n) via a mobile application (i.e. “mobile app”).

Network 108 comprises a publicly accessible network, such as the Internet, which handles communication between the client devices 106(1)-106(n) and the servers 102(1)-102(n). However, it is contemplated that the network 108 may comprise other types of private and public networks. Communications, such as requests from client devices 106(1)-106(n) and responses from servers 102(1)-102(n), preferably take place over the network 108 according to standard network protocols, such as the HTTPS, UDP, and TCP/IP protocols and the like. In an aspect of the present disclosure, communications, such as requests and responses relating to user account data between servers 102(1)-102(n) are in a format that is compliant with one or more established standardized secure messaging schemes already used between financial institutions all over the world.

Further, it should be appreciated that the network 108 may include local area networks (LANs), wide area networks (WANs), direct connections and any combination thereof, as well as other types and numbers of network types. On an interconnected set of LANs or other networks, including those based on differing architectures and protocols, routers, switches, hubs, gateways, bridges, and other intermediate network devices may act as links within and between LANs, WANs and other networks to enable messages and other data to be sent and received between network devices. Also, communication links within and between LANs and other networks typically include twisted wire pair (e.g., Ethernet), coaxial cable, analog telephone lines, mobile cell towers, full or fractional dedicated digital lines including T1, T2, T3, and T4, Integrated Services Digital Networks (ISDNs), Digital Subscriber Lines (DSLs), wireless links including satellite links and other communications links known to those skilled in the relevant arts.

LAN 104 may comprise one or more private and public networks which provide secured access to the servers 102(1)-102(n). As discussed above, communications, such as requests and responses relating to user account data between servers 102(1)-102(n) are in a format that is compliant with one or more established standardized secure messaging schemes already used between financial institutions all over the world. These types of existing standardized messaging schemes used between financial institutions over WANs and LANs is well known and is not described in detail herein.

The servers 102(1)-102(n) comprise one or more network devices or machines capable of operating one or more Web-based and/or non Web-based applications that may be accessed by other network devices (e.g. client devices, other servers) in the network 108. Such data includes, but is not limited to Web page(s), image(s) of physical objects, user account information, and any other objects and information. It should be noted that the servers 102(1)-102(n) may perform other tasks and provide other types of resources.

As will be discussed in more detail below, one or more servers 102 handled by a particular financial institution may comprise a cluster of a plurality of servers which are managed by a network traffic management device (e.g. firewall, load balancer, web accelerator), gateway device, router, hub and the like. In an aspect, one or more servers 102(1)-102(n) may implement a version of Microsoft® IIS servers, RADIUS servers and/or Apache® servers, although other types of servers may be used and other types of applications may be available the on servers 102(1)-102(n). It is also contemplated that the finance application module 300 is configured to be agnostic of the server software and thus can be implemented and executed on any server running any type of proprietary software.

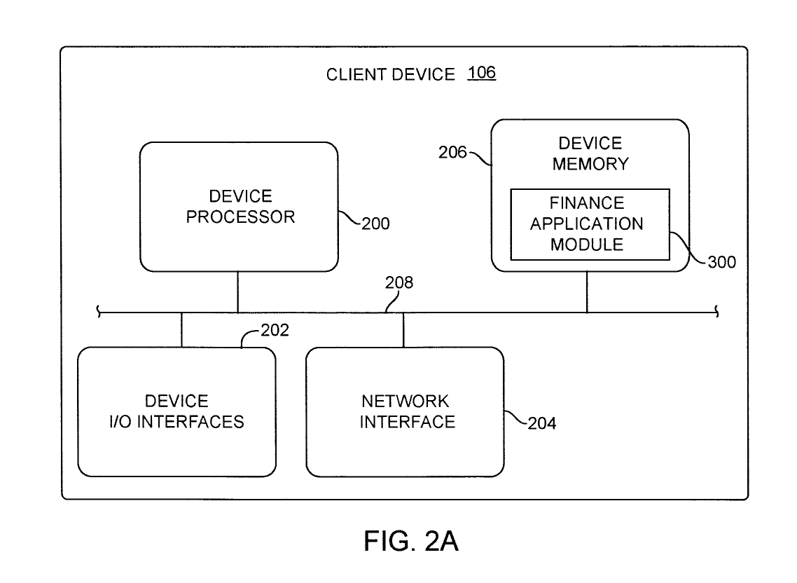

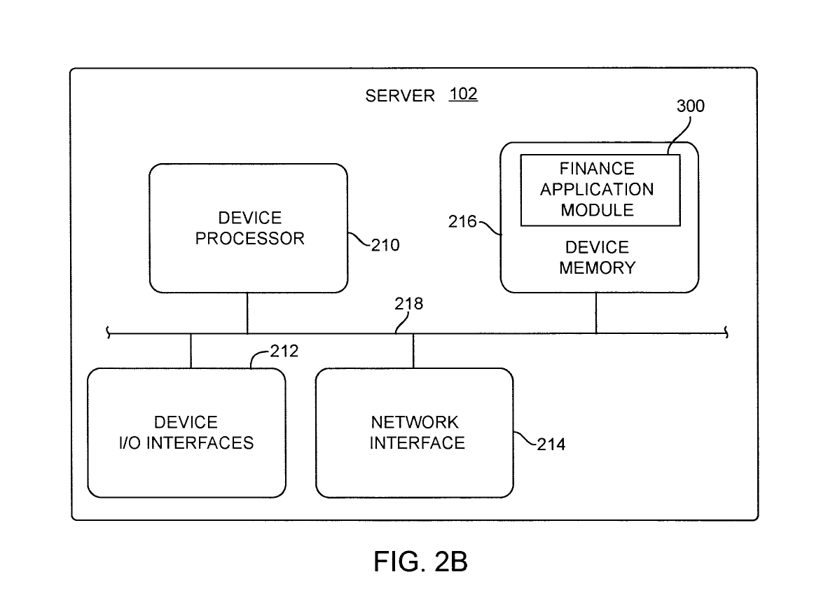

FIG. 2A illustrates a block diagram of a client device 106 shown in FIG. 1 in accordance with an aspect of the present disclosure. As shown in FIG. 2A, an example client device 106 includes one or more device processors 200, one or more device I/O interfaces 202, one or more network interfaces 204 and one or more device memories 206, all of which are coupled together by one or more buses 208. It should be noted that the device 106 could include other types and numbers of components.

FIG. 2B illustrates a block diagram of a server 102 shown in FIG. 1 in accordance with an aspect of the present disclosure. With regard to FIG. 2B, an example server 102 is shown which includes one or more device processors 210, one or more device I/O interfaces 212, one or more network interfaces 214 and one or more device memories 216, all of which are coupled together by one or more buses 218. It should be noted that the server 102 could include other types and numbers of components.

Device processor 200, 210 comprises one or more microprocessors configured to execute computer/machine readable and executable instructions stored in the respective local device memory 206, 216 or in a remote device memory (not shown). Such instructions are implemented by the processor 200, 210 to perform one or more functions described below. It is understood that the processor 200, 210 may comprise other types and/or combinations of processors, such as digital signal processors, micro-controllers, application specific integrated circuits (“ASICs”), programmable logic devices (“PLDs”), field programmable logic devices (“FPLDs”), field programmable gate arrays (“FPGAs”), and the like. The processor 200, 210 is programmed or configured to execute the process in accordance with the teachings as described and illustrated herein of the novel system and method described below.

Device I/O interfaces 202, 212 comprise one or more user input and output device interface mechanisms. The interface may include a computer keyboard, touchpad, touchscreen, mouse, display device, and the corresponding physical ports and underlying supporting hardware and software to enable communications with other network devices in the system 100. Such communications include, but are not limited to, accepting user data input and providing output information to a user, programming and administering one or more functions to be executed by the corresponding device and the like.

Network interface 204, 214 comprises one or more mechanisms that enable the client devices 106 and/or the servers 102 to engage in TCP/IP communications over the LAN 104 and network 108. In aspect, the network interface 204, 214, among other things, can be configured to aid in the handling, receipt and transmission of secured data sent between two or more network devices via a protocols that facilitate efficient messaging in compliance with one more message standards.

However, it is contemplated that the network interface 204, 214 may be constructed for use with other communication protocols and types of networks. Network interface 204, 214 is sometimes referred to as a transceiver, transceiving device, or network interface card (NIC), which transmits and receives network data packets over one or more networks, such as LAN 104 and network 108.

In an example where the client device 106 and/or server 102 includes more than one device processor 200, 210 (or a processor 200, 210 has more than one core), each processor 200, 210 (and/or core) may use the same single network interface 204, 214 or a plurality of network interfaces 204, 214 to communicate with other network devices. Further, the network interface 204, 214 may include one or more physical ports, such as Ethernet ports, to couple its respective device with other network devices in the system 100. Moreover, the network interface 204, 214 may include certain physical ports dedicated to receiving and/or transmitting certain types of network data, such as device management related data for configuring the respective device, data in the form of messages in accordance with existing secured messaging schemes, and the like.

Bus 208, 218 may comprise one or more internal device component communication buses, links, bridges and supporting components, such as bus controllers and/or arbiters. The bus enable the various components of the device 102, 106, such as the processor 200, 210, device I/O interfaces 202, 212, network interface 204, 214, and device memory 206, 216, to communicate with one another. However, it is contemplated that the bus may enable one or more components of its respective device 102, 106 to communicate with components in other devices as well. Example buses include HyperTransport, PCI, PCI Express, InfiniBand, USB, Firewire, Serial ATA (SATA), SCSI, IDE and AGP buses. However, it is contemplated that other types and numbers of buses may be used, whereby the particular types and arrangement of buses will depend on the particular configuration of the device 102, 106 which houses the bus.

Device memory 206, 216 of the client device 106 or server 102 comprises computer readable media, namely computer readable or processor readable storage media, which are examples of machine-readable storage media. Computer readable storage/machine-readable storage media may include volatile, nonvolatile, removable, and non-removable media implemented in any method or technology for storage of information. Such storage media stores computer readable/machine-executable instructions, data structures, program modules and components, or other data, which may be obtained and/or executed by one or more processors, such as device processor 200, 210. Such stored instructions allow the processor to perform actions, including implementing an operating system for controlling the general operation of the client device 106 and/or server 102 to perform one or more portions of the novel process described below.

Examples of computer readable storage media include RAM, BIOS, ROM, EEPROM, flash/firmware memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Such desired information includes data and/or computer/machine-executable instructions and which can be accessed by the network devices 102, 106.

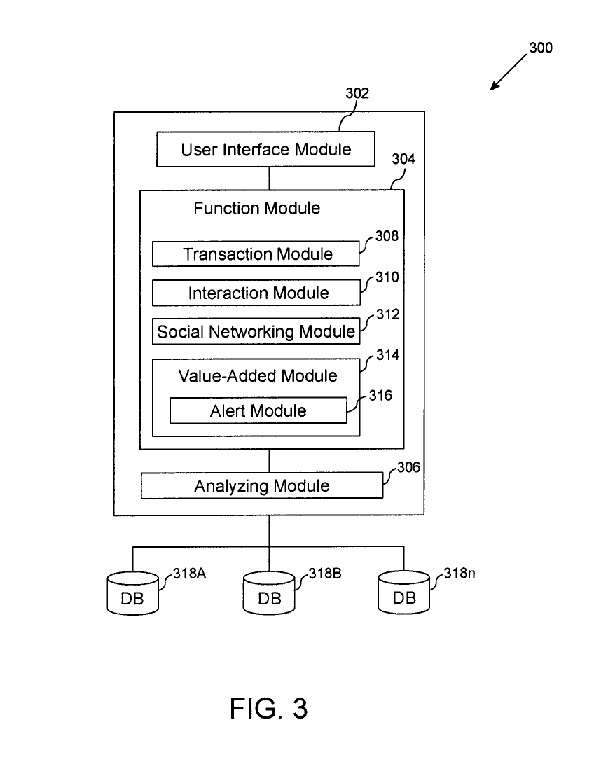

FIG. 3 illustrates a block diagram of the centralized finance application module in accordance with an aspect of the present disclosure. In general, the financial application module is configured to provide a centralized user interface that enables the user to access and view general and detailed account information for each of his/her accounts held at a variety of different financial institutions. The centralized financial application module 300 also enables the user to submit transaction order instructions via a user interface, whereby the module 300 will communicate the order instructions to the appropriate financial institution to execute. Further, the centralized financial application module 300 can be configured to allow the user access to his/her subscribed user accounts from the different institutions without having to provide login and password information for any of those institutions' websites. As will be explained below, the centralized financial application module 300 can be configured to utilize features and solutions that greatly enhance the user's experience in managing his/her finances among multiple financial institutions.

In an aspect, as shown in FIG. 3, at least a portion of the finance application module 300 is implemented in and executed by one or more Web-based or non Web-based servers 102 that is independent and remote from the core servers of the financial institutions 102(1)-102(n). In an aspect, the finance application module 300 may incorporate a web-application module which provides a dedicated web page having a user interface through which the user interacts with the finance application module 300.

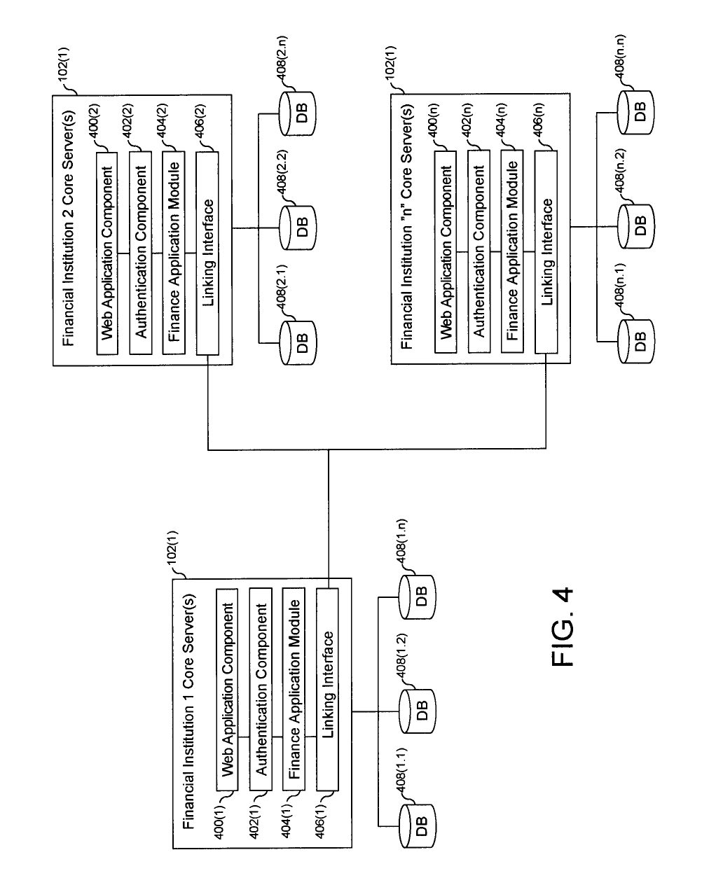

In an aspect, as shown in FIG. 4, the finance application module 300 may be implemented in and executed by one or more core servers 102(1)-102(n) handled by one or more financial institutions. In an aspect, the server which implements the finance application module 300 which then can operate and communicate with other servers 102 handled by the financial institution. In this aspect, the finance application module 300 would operate with the financial institution's web server and to be implemented in the financial institution's own website.

In an aspect, it is contemplated that at least a portion of the finance application module 300 may be implemented in and executed in one or more client devices 106. In an example, the client device 106 may be a personal computer, laptop, smart phone, tablet, or smart television in which at least a portion of the financial application module 300 is accessed by the user by selecting a client application, accessing a website or selecting a mobile application. It should be noted, however, the system 100 may be configured to include one or more of the above examples where the finance application module 300 is implemented in and executed by different network devices.

In an aspect, the finance application module 300 as well as its various modules and sub-modules comprise software based machine executable code located in a memory which causes one or more machine processors to execute the instructions which allow the financial application module 300 and its separate modules to effectively perform their functions. However, it is contemplated that the financial application module 300 may alternatively be implemented and executed on a hardware device.

The finance application module 300 generally includes a user interface module 302, a function module 304 and an analyzing module 306. In an aspect, the function module 304 of the finance application module 300 may include a transaction module 308, an interaction module 310, a social networking module 312, a value-added module 314, and an alert module 316. It should be noted that the configuration of the finance application module 300 shown in FIG. 3 is exemplary and may include more or lesser number of modules. In an aspect, one or more of the component and sub-component modules shown within the finance application module 300 in FIG. 3 may be located outside of the finance application module 300 in accordance with an aspect of the present disclosure.

The user interface module 302 provides the user interface which is displayed to the user and allows the user to operate and take advantage of the finance application tool 300. In particular, the user interface module 302 is configured to provide the user interface in the form suitable for the client device 106 which the user will use. The user interface module 302 communicates user input to the function module 304 to perform various tasks and also provides information from the function module 304 to the user via the user interface.

In an aspect, the user interface provided by the user interface module 302 allows the user to view general and detailed account information for each account that is held at other subscribing financial institutions. The user interface also allows the user to initiate and schedule transaction orders (e.g. selling stock, paying bills and/or loans, transferring assets, applying for services and products, and the like) which are handled by the finance application tool 300. The user interface further provides the user with access to interactive services provided by financial institutions or other individuals. More details about these features are described below.

As stated above, the finance application tool provides a centralized interface where the user can securely access his/her account information from various financial institutions without having to independently visit the institutions' websites and/or provide institution-specific login/password information. In general, the finance application module 300 is configured to utilize secured standardized finance messaging schemes or protocols to enable communications and exchange of secured sensitive user account information between the finance application module and the core servers of the subscribing financial institutions.

In an aspect, the transaction module 308 of the finance application module 300 enables the consumer to utilize one or more transaction services that are offered by the financial organizations' servers 102. In particular, the transaction module 308 offers transaction services to the consumer such that the consumer may implement and execute one or more transactions using one or more consumer accounts via the financial organizations' servers. Such transaction services include, but are not restricted to, transferring money between accounts, depositing money into one or more accounts, withdrawing money from one or more accounts, inter-bank transfers, bill pay services, requesting loans and/or repayment of loans, implementing the buying and/or selling of securities, check writing and ordering services, notary services as well as other monetary and non-monetary services. The transaction module 308 works along with the user interface module 302 and the linking interface 406 such that the transaction module 308 is able to pass transaction instructions and orders placed by the user to the appropriate financial institutions using messages that are in compliance with one or more standardized finance-based messaging schemes.

Regarding the memory 318, it is contemplated that various modules may be configured to store customer and/or financial institution actions in the memory, whereby such stored information may be later retrieved based on the need for such information. It should be noted that although memory 318 is shown in the finance application module 300, this is only for explanation purposes. As stated above, it is contemplated in an aspect that the finance application module 300 resides in a memory 208, 218 of the client devices 106(1)-106(n) and/or servers 102(1)-102(n).

The finance application module 300 is configured to communicate with a linking interface 302 that is at least partially implemented in a network device (e.g. server 102, client device 106) to enable message-based communications with the financial institutions' core servers 102(1)-102(n). As will be discussed in more detail below, the core servers 102(1)-102(n) also include a linking interface which enables the core servers 102(1)-102(n) to communicate with one another as well as the finance application too 300 using messages in compliance with one or more standardized financial-based messaging schemes.

As stated above, the financial application module 304 sends requests and receives secured account information from subscribing financial institutions in the form of messages in compliance with one or more standardized financial-based messaging schemes. Secured account information includes, but is not limited to, the user's asset and liability information, cash holdings in one or more customer bank accounts (e.g. checking accounts, saving accounts, money market accounts, 401K accounts, investment products and the like), day-to-day transaction and history information, credit information, payment due dates, interest rates, bill pay transactions, inter-account transaction information, inter-bank transaction information, loan information, securities information, mortgage information, and the like. It should be noted that the above list for account information are examples, whereby account information can encompass any information that can be otherwise provided by a financial institution to a requesting customer.

It is also contemplated that the financial application module 300 is configured to allow the user to initiate commands or transaction order instructions from the user interface. In this example, the function module 304 provides transaction order instruction to linking interface 404 which then sends the transaction order to the appropriate financial institutions' core servers 102(1)-102(n) in the form of a message that is compliant with one or more standardized financial-based messaging schemes. The core server, upon receiving the message, executes the order and transmits a confirmation message, compliant with one or more standardized financial-based messaging schemes, back to the financial application module 304. The linking interface 302, upon receiving the confirmation message as well as any other information from the subscribing financial institutions' core servers 102(1)-102(n), compiles it and provides it to the financial application module 304 to process and display on the user interface.

In an aspect, the secured messages are configured to comply with one or more standardized financial-based messaging schemes or protocols. Such schemes and protocols include, but are not limited to, the SWIFT messaging scheme, the IFX messaging protocol, the OFX messaging protocol and the like. In an aspect, messages are encrypted and communicated between core servers via their linking interfaces over a secured communication channel independent of traffic. In another aspect, messages are communicated between core servers over a secured HTTP, TCP/IP or the like connection. It should be noted that although SWIFT, IFX and OFX are specifically mentioned, any other financial-based secured messaging scheme or protocol may be used with the present system and method. The secured financial-based messaging scheme serves as a preferred means of sending user initiated requests and user account information among the financial institutions as banks and other financial entities already use such communication means to communicate transaction data. The finance application module 300 takes advantage of this existing secure communication means to communicate requests and receive account information from subscribing financial institutions.

Additionally, the built-in security of the standardized messaging schemes allow user account information to be shared between institutions without requiring the user to provide specific login/password information. Instead, the user will provide unique identification information (e.g. social security number, driver's license information, birth information) to the finance application module 300 at the onset when he/she is registering with the module 300. In addition, considering that the user typically needs to provide this type of information to the financial institution when he/she opens an account, the finance application module 300 can easily confirm the user's identity with the subscribing financial institutions by comparing this commonly known information.

Accordingly, the user is not required to provide login/password information for each individual financial institution when obtaining account information via the finance application module 300. This is advantageous as the user need provide his/her login and password authentication information only to access the user interface of the finance application module 300 to view his/her account information and conduct transactions among multiple financial institutions, as will be discussed in more detail below. The finance application module 300 is also configured to provide a secure online experience to the consumer such that the consumer is able to conduct financial transactions in his/her accounts via the finance application module 300 as well as be able to interact with other consumers and/or financial advisors without any threat that his/her sensitive and confidential information will be compromised.

FIG. 4 illustrates a block diagram of a plurality of core servers 102(1)-102(n) handled and operated by different financial institutions in accordance with an aspect of the present disclosure. As shown in FIG. 4, a first core server 102(1) operated by a first financial institution is shown along with a second core server 102(2) operated by a second financial institution up to an n^{th} core server 102(n) operated by n^{th} financial institution. In an aspect, the first core server 102(1) is operated independent of any other financial institution and is thus not operated by a financial institution other than the first financial institution.

In particular to an aspect, one or more of the core servers 102(1)-102(n) include a web application component 400(1)-400(n), an authentication component 402(1)-402(n), and the financial application module component 404(1)-404(n). Each server 102 includes a respective linking interface 406(1)-406(n) configured to transmit and receive messages in compliance with one or more standardized financial-based messaging schemes.

It should be noted that the configuration of the core servers 102(1)-102(n) shown in FIG. 4 is exemplary and may include more or lesser number of modules and/or components. It should also be noted that the internal configurations of the core servers 102(1)-102(n) shown in FIG. 4 are exemplary and are thus not limiting to what is shown in FIG. 4. For example, core server 102(1) may include a user interface module 400(1), an authentication module 402(1), and a financial application module 404(1), whereas core server 102(2) may not include a user interface module 400(1), user interface module 402(1) and/or a financial application module 404(2), but only provides data messages via its linking interface. In other words, although all the core servers are shown in FIG. 4 as containing the same components, one or more core servers may have some or all of the shown components while other core servers contain other or additional components. It should also be noted that although it is shown in FIG. 4 that each core server houses the individual modules and/or components, it is contemplated that one or more modules and/or components may be located on separate servers operated by the financial institutions or other entities.

In aspect, a financial institution may configure its system such that one or more of its servers are dedicated to serving the functions of one or more of the particular modules and/or components shown in FIG. 4. For example, a financial institution's network system may be configured in such a way that it comprises one or more servers which handle the functions of the web application component; one or more servers which handle the functions of the authentication component; one or more servers which handle the functions of the financial application module; and/or one or more servers which handle the functions of the linking interface; and so on.

In an aspect, the components and modules shown in FIG. 4 are software based and are housed in a memory 216 (FIG. 2B) within or remote from one or more servers 102(1)-102(n), whereby the components and modules contain programmed executable instructions which are configured to be run by one or more processors 210 (FIG. 2B) to perform the functions described herein. Additionally/alternatively, the components are at least partially configured within one or more hardware components listed and described above.

As shown in the example in FIG. 4, the web application component 400(1)-400(n) serves to provide web based services to client devices 106(1)-106(n). The authentication component 402(1)-402(n) handles user authentication information received from the client devices 106(1)-106(n) and communicates it to an authentication database 408 to confirm whether the user is able to access account information from the financial institution.

The financial application module 404(1)-404(n), as described in detail above, processes requests, commands and/or instructions sent from the user via the user interface displayed on a client device and communicates those commands in standardized message form to one or more appropriate core servers 102(1)-102(n) of the other financial institutions using the linking interfaces 404. The financial application module 404(1)-404(n) also processes, aggregates and/or compiles user account information received from one or more core servers 102(1)-102(n) of the financial institutions.

As stated above, the linking interface 406(1)-406(n) enables communications to occur between two or more servers where at least one of the servers implements the financial application module 300 which communicates with the server(s) handled by financial institution(s). In particular, a requesting financial institution is able to request and receive secured account information of the user's account from another financial institution where that user has an account.

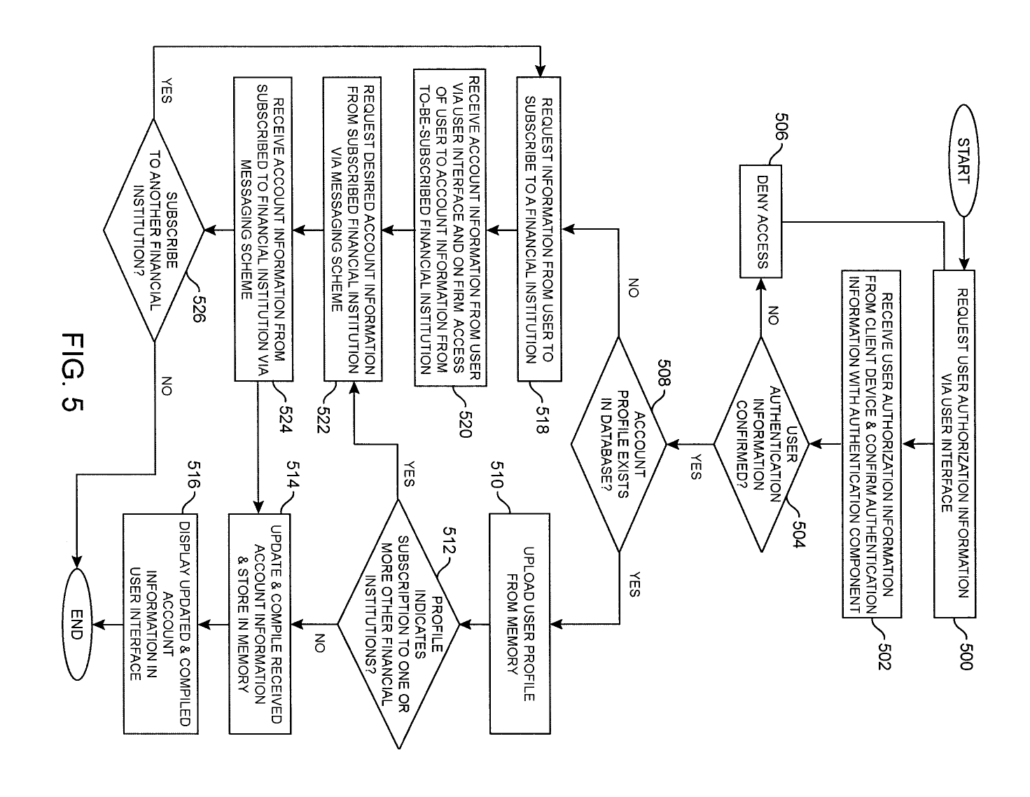

FIG. 5 illustrates a flow chart representing an aspect of the process performed by at least the financial application module in accordance with an aspect of the present disclosure. As shown in FIG. 5, the process begins with a user visiting the user interface provided by the user interface module 302 of the finance application module 300. Upon visiting the user interface, the user is prompted to input his or her authorization credentials information, such as a login and password, although other information may be requested of the user (Block 500). For instance, when initially registering with the financial application module 300, the user may be asked to provide information unique to the user (e.g. social security number, birth date information, and the like). Thus, when accessing the financial application module 300, the user will be requested to provide his/her unique identification information, as opposed to a login/password, to access the module 300. In an aspect, the user's unique identification information is stored in the servers of the financial institutions where the user has an account. Thus, two or financial institutions which are tasked to share account information between each other can securely do so by confirming the user's unique identification information.

In an aspect, the finance application module 300 requests the user to input authentication information that is unique and is not an already registered to a financial institution where the user has an account. This unique authentication information can be stored as user profile information in a local or remote memory, whereby the authentication information can only be accessed by the finance application module 300 and is not shared with any other core servers of other financial institutions. In another aspect, the finance application module 300 allows the user to provide already registered authentication information that he/she would normally enter to access his/her account at a particular financial institution. In this example, the financial institution to which the authentication information has already been registered would serve as a primary node. Additionally, all other subscribed-to financial institutions would serve as secondary nodes that are paired with the primary node and communicate the user's account information with the primary node using the standardized messaging scheme.

After the user inputs his/her authentication information, the authentication information is received by the finance application module 300, whereby the finance application module 300 communicates and confirms the user's authentication information with the authentication component 402 that accesses an authentication database (Block 502). If the authentication component 402 does not confirm that the authentication information is correct (Block 504), the user is denied access (Block 506) and is requested user to again input his/her authentication information (Block 500).

If the authentication component 402 confirms that the authentication information is correct, the finance application module 300 determines whether the user account profile exists in a memory (Block 508). As stated above, in an aspect, the user profile contains all information about the user and the user's account information that can be used by the financial application module 300 in performing one or more of the functions described herein. Such profile information includes, but is not limited to, information of all user accounts as well as the financial institutions to which the user is currently subscribing, information of the financial institutions which the user is subscribing to as well as information regarding their corresponding core servers, the user's asset and liability information, cash holdings in one or more customer bank accounts (e.g. checking accounts, saving accounts, money market accounts, 401K accounts, and the like), day-to-day transaction and history information, credit information, payment due dates, interest rates, bill pay transactions, inter-account transaction information, inter-bank transaction information, loan information, securities information, mortgage information, user preferences and the like.

If the financial application module 300 determines that user account profile information is found in the memory, the financial application module 300 uploads the user profile information from the memory (Block 510). Upon retrieving the user account profile, the financial application module 300 determines whether the user, via the financial application module 300, has currently subscribed to receive information regarding one or more accounts being held at one or more other financial institutions (Block 512). If not, the financial application module 300 compiles and updates account information retrieved from the user account profile information (Block 514). The financial application module 300 then displays the compiled updated data on the user interface (Block 516).

Returning to Block 512, if the user profile indicates that the user is subscribed to, and thus has an account with, one or more other financial institutions, the finance application module 300 utilizes the linking interface 406 to contact the subscribed-to financial institutions via the standardized messaging scheme and request updated user account information from the subscribed-to financial institutions (Block 522). The financial application module 300, via the linking interface 302), thereafter receives the updated account information from the subscribed-to financial institutions via the standardized messaging scheme (Block 524). The received updated account information is then compiled and updated as well as stored by the financial application module 300 (Block 514). The financial application module 300 then displays the compiled updated data on the user interface (Block 516).

Returning to Block 508, if the financial application module 300 determines that no user account profile exists, the financial application module 300 will create a new user account profile and request the user to identify the financial institutions and the accounts which the user would like to subscribe to (Block 518). Upon receiving the necessary information from the user, the financial application module 300, via the linking interface, will send requests to the one or more financial institutions to confirm access to the user's one or more accounts (Block 520). Such requests may contain user authentication information or other requisite information which the receiving financial institution can use to confirm that the institution holds an account for that user and whether the account information is approved for sending back to the financial application module 300. Upon being notified that access to the user account information has been granted, the financial application module 300, via the linking interface, sends one or more requests for account information, with or without user authentication information, to the core-server(s) of the then-subscribed financial institutions (Block 522). It should be noted that the requests are sent via the linking interface 406, whereby the requests are in the form of messages in compliance with one or more standardized finance-based messaging schemes. The financial application module 300 thereafter receives the requested account information in the form of messages that are compliant with the one or more standardized finance-based messaging schemes from the subscribed financial institution(s) (Block 524). The received updated account information is then compiled and updated as well as stored by the financial application module 300 (Block 514). The financial application module 300 then displays the compiled updated data on the user interface (Block 516). Additionally, the process continues whereby the user is requested if he/she would like to subscribed to another financial institution (Block 526). If the user replies yes, the process returns to Block 518; otherwise the process ends.

It should be noted that anytime a change occurs to one or more of the user's subscribed accounts while the user is logged into the financial application module 300, the subscribed financial institution will send a message of the change to the financial application module 300. This information is then compiled and updated by the financial application module 300 on the displayed user interface. In another aspect, any changes occurs to one or more of the user's subscribed accounts, while the user is not logged into the financial application module 300, may still be sent from the subscribed financial institution to the financial application module 300 while it is off-line. These received messages may be queued in the user profile information and be compiled and updated the next time the user logs into the financial application module 300. In either aspect, the user is provided the most up to date information of all his/her subscribed accounts upon logging into the financial application module 300. In particular, the financial application module 300 will receive real time information of all the subscribed accounts when the user is on-line with the financial application module 300.

Referring back to FIG. 3, the interaction module 310 of the finance application module 300 enables consumers to utilize one or more interactive services that may be offered by the financial organizations via their core servers 102(1)-102(n). The interaction module 310 may provide various interactive services to users that may allow them to interact with other users that have accounts at one or more common financial institutions or use the finance application module 300. For example, a user may be allowed to interact with, seek advice and/or resolve queries with other users and/or representatives of one or more financial institutions using the finance application module 300. In aspect, the interaction module 310 may allow one or more users to rate one or more products and/or services offered by one or more financial institutions and/or take part in various interactive activities, such as polling, surveys, and opinions. The interaction module 310 may be configured to provide this information to the financial institutions to improve their own services/products. Financial institutions may also publish such ratings and polls for other individuals associated or unassociated with the financial institutions.

As shown in FIG. 3, the finance application module 300 may include a social networking module 312 (hereinafter referred to as “SNM 312”) which enables users to utilize one or more social networking services associated with one or more financial institutions. Social networking services may allow users to interact among themselves and with unregistered users. Unregistered users may include, but are not limited to, social groups from social networking websites such as Facebook®, Twitter®, Orkut®, LinkedIn® and the like. The SNM 312 may provide features to enable the user to set his/her own goals or set goals with others in a closed community, learn about and engage in peer-to-peer money lending transaction features, access recommendations, and utilize blogging capabilities.

For example, users may set a monetary goal and share it among other known users and social groups using the SNM 312 or may want to know about goals set by other users in the same community to understand how people with similar profiles and wants are achieving their financial objectives. In another example, users may use the SNM 212 to correspond with others in their network for borrowing or lending purposes, recommending or querying one or more financial institutions' products and services, gathering information, and the like. In an aspect, the financial institutions' to initiate and institute viral marketing campaigns for their various products and services using various social groups of users via the SNM 312.

Referring to the value-added module 314 of the finance application module 300, the value-added module 314 allows users to utilize one or more value-added services that may be offered by one or more financial institutions. In an example, the value-added module 314 may enable users to download widgets to one or more client devices 106 via the finance application module 300, whereby the widgets may be configured to allow the users to view their account balances, payments, bills, stock tickers, RSS feeds, and the like. In an aspect, the value-added module 314 allows users to utilize online demos and videos associated with the product(s) and/or service(s) to inform them about the features associated with the product(s) and/or service(s). In an aspect, the value-added module 314 includes an alert module 316 which enables the users to receive alerts and rewards (incentives) corresponding to services offered by one or more financial institutions. The value-added module 314 can also provide product comparators and selectors that help customers to select products from different financial institutions that suit their needs better.

In an aspect, the finance application module 300 includes an analyzing module 306 which analyzes the various actions performed and/or features used by the users when they access features and services provided by the financial institutions. In an aspect, the analyzing module 306 can implement a budgeting solution which leverages the capabilities of the finance application module 300 to be compile and aggregate account information from various different financial institutions and uses this information to allow the user to plan and create as well as execute and monitor one or more budgeting programs. The analysis of expenses for the users can be used by the analyzing module 306 to track and suggest appropriate budgets based on spending pattern analysis. Financial institutions can gain valuable information regarding their customers using the analyzing module 306, value-added module 314 and/or the SNM 312 to analyze customers spend/savings patterns, and provide tips for better savings and cost cutting as well as identify cross selling and up selling opportunities.

In an aspect, the analyzing module 306 may analyze information gathered when the user performs an action handled by any of the other modules of the financial application module 304 (e.g. transaction module, SNM). For example, the analyzing module 306 may be used to analyze the results of customer-based opinions, surveys, and/or polls which correspond to at least one of the products/services provided by a financial institutions, whereby the results of the analysis may be provided back to a requesting financial institution for marketing research purposes, evaluating existing or new features and/or to enhancing the quality of designated products/services. These results may be provided to financial institutions by the finance application module 300 in the form of predetermined or customized reports.

In an aspect, the analyzing module 306 may retrieve and analyze user input information that is recorded and stored by another module in the finance application module 300. For example, the analyzing module 306 may retrieve and analyze recommendations provided for one or more products and services by other users, whereby the results of the analysis may be provided to one or more designated financial institutions. In the example, the results provided by the analyzing module 306 may be such that the financial institution can use the results to initiate a viral marketing campaign.

The finance application module 300, by utilizing one or more of the above modules, is able to provide not only budgeting features but also financial management solutions. By receiving and tracking account information from multiple financial institutions, the finance application module 300 utilizes one or more of the above modules to track assets and total net worth; pre-define personalized tags for tagging spend and income categories; and provide multiple level tagging in which the user can define the tag level to consolidate the spend and income categories at different levels. Further, finance application module 300, by utilizing one or more of the above modules, can provide visual representations of the spend and income patterns for a user defined monitoring period and also provide a history of spend and income patterns.

Accordingly, the finance application module leverages its data aggregation capabilities to provide an integrated set of tools, including budget creation, spend vs. income tracking, financial health checks, goal sharing and advisory services, to enable customers to have better control of their finances and enable them to take informed decisions.

With regard to the modules and sub-modules discussed above in the financial application module 300 in FIG. 3, an example scenario is provided in which the financial application module 300 is able to provide a rich variety of services and solutions to the user. It should be noted that the following is only an example which describes some of the features of the financial application module and is thereby not limiting.

In the example, a user utilizes the financial application module 300 to subscribe to Bank 1 where the user has a salary account (having $15,000), a savings account (having $15,000) and a home loan account (having an outstanding mortgage of $50,000). Using the financial application module 300, the user may subscribe to Bank 2 and designate which of his/her accounts at Bank 2 are to be displayed on the financial application module's 300 user interface. In the example, the financial application module 300 receives information of the user's account(s) from subscribed Bank 2 and displays that the user has a car that is being financed by Bank 2 with $3,000 left until it is paid off. It is also contemplated that the user may manually create accounts and record his/her assets/liabilities in the manually created accounts, whereby information of the manually created accounts along with the subscribed accounts are displayed on the user interface of the financial application module 300.

The financial application module 300 has the ability to leverage its ability to aggregate account information from different subscribed financial institutions and provide the user with the ability to conduct transactions between and among those subscribed financial institutions. In an example, a user may want to buy a new car by end of the year. The financial application module 300 provides the user the ability to use the various modules to plan (and achieve) a financial goal to purchase the car by year end. The system may have pre-configured goals which may be common to many purchasers, or may have the option to create custom goals as defined by the user. Each goal may have certain parameters that are predefined or can be defined by the user and are displayed in the user interface so that the user can track these goals to completion. In the example, the parameters can be established to be the Purchase price of the car, date by which the car is to be purchased, details of the car and expected monthly payments. The financial application module 300 may provide the user with access to self help documents which details how to plan a goal, how to track the goal to completion, how to achieve the goal, etc.

The financial application module, by using its SNM 312 and interaction module 310, allows the user to check whether there are other customers with similar goals, and how they have gone about achieving the same. Customer may access blogs, online communities and online forum available via the financial application module 300 to get more details about the same. While utilizing the interaction and social networking modules 310, 312, the user may come across a “Flexi Vehicle Loan” plan that is offered by Bank 3 which other users with similar goals have recommended.

The financial application module 300 may detect the actions and inputs of the user and utilize a rule engine implemented by the value added module 314 to prompt the user with suggestions such as available loans and interest rates that may be attractive to the user based on the amount of cash in the user's account, repossessed vehicles for sale that match the description of the desired vehicle and the like.

The financial application module 300 allows the user to use the interaction module 310 to contact a Relationship Manager of an existing subscribed bank (e.g. Bank 1 and Bank 2) or another financial institution. The user is able to do this in an aspect by selecting a “Remote Assist (video)” or “Remote Assist (Audio)” link. Upon the user selecting the Remote Assist link, the request is routed to a relationship manager/other manager with contextual information that user has searched for Vehicle Loan Products. On receiving the remote assist request, the relationship manager initiates a video conference with the user via the user interface. In the example, the user and relationship manager are able to negotiate the terms of a vehicle loan with Bank 4, which the user is unsubscribed with. After negotiating the terms, the user decides to apply for the loan through Bank 4, whereby the user or relationship manager are able to set up a loan account. Thereafter, Bank 4 is able to contact the financial application module 300 and automatically set up a subscription using the messaging scheme discussed above. The user is then able to automatically deduct the loan amount from Bank 4, transfer it to another subscribed bank as well as make payments to the loan via the module 300. This can be further extended that the relationship manager can suggest products of partner organizations of the bank, which can be accessed and brought through the bank's current channel solutions.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. A method of providing a centralized financial management tool comprising:
executing a financial application module implemented on a network device, the network device including a linking interface configured to operate with the financial application module;
requesting first account information for a user from a first server of a subscribed first financial institution, the request communicated from the financial application module, wherein the request is sent from the linking interface as one or more messages in compliance with a standardized messaging scheme;
receiving the first account information at the linking interface of the network device, the first account information transmitted from the first server of the subscribed first financial institution as one or more transmitted messages in compliance with the standardized messaging scheme;
compiling the first account information from the first server; and
displaying the compiled first account information in the user interface.

2. The method of claim 1, wherein the network device further comprises a server handled by a financial institution, wherein the server includes the financial application module and the linking interface.

3. The method of claim 2, further comprising:
receiving a user instruction via the user interface to obtain second account information from a second server of a subscribed second financial institution;
requesting the second account information from the financial application module, wherein the request is sent from the linking interface of the first server to a corresponding linking interface of the second server as one or more messages in compliance with a standardized messaging scheme;
receiving the second account information at the linking interface of the first server from the second server of the subscribed second financial institution as one or more transmitted messages in compliance with the standardized messaging scheme;
compiling the second account information on the first server; and
displaying the compiled second account information in the use interface.

4. The method of claim 1, further comprising:
receiving authentication information of the user to access the financial application module, wherein the authentication information is unique to the financial application module and is different than user authentication information associated with accessing the second financial institution directly through a dedicated website of the second financial institution.

5. The method of claim 1, wherein the account information comprises at least transaction information that is categorizable by a user in the financial application module.

6. The method of claim 1, wherein the account information of the first and second user accounts are continually updated via continuously communicating messages between the network device and the first server.

7. The method of claim 1, further comprising providing a budgeting feature to the user using compiled first and second account information from one or more financial institutions.

8. The method of claim 1, further comprising providing an analyzing feature configured to analyze user activities among one or more accounts of one or more financial institutions.

9. A non-transitory machine readable medium having stored thereon instructions for providing a centralized financial management tool, comprising machine executable code which when executed by at least one machine, causes the machine to:
execute a financial application module and a linking interface configured to operate with the financial application module;
request first account information for a user from a first server of a subscribed first financial institution, the request communicated from the financial application module, wherein the request is sent from the linking interface as one or more messages in compliance with a standardized messaging scheme;
receive the first account information at the linking interface of the network device, the first account information transmitted from the first server of the subscribed first financial institution as one or more transmitted messages in compliance with the standardized messaging scheme;
compile the first account information from the first server; and
display the compiled first account information in the user interface.

10. The machine readable medium of claim 9, wherein the network device further comprises a server handled by a financial institution, wherein the server includes the financial application module and the linking interface.

11. The machine readable medium of claim 10, wherein the machine executable code which when executed by at least one machine, causes the machine to:
receive a user instruction via the user interface to obtain second account information from a second server of a subscribed second financial institution;
request the second account information from the financial application module, wherein the request is sent from the linking interface of the first server to a corresponding linking interface of the second server as one or more messages in compliance with a standardized messaging scheme;
receive the second account information at the linking interface of the first server from the second server of the subscribed second financial institution as one or more transmitted messages in compliance with the standardized messaging scheme;
compile the second account information on the first server; and
display the compiled second account information in the use interface.

12. The machine readable medium of claim 9, wherein the machine executable code which when executed by at least one machine, causes the machine to:
receive authentication information of the user to access the financial application module, wherein the authentication information is unique to the financial application module and is different than user authentication information associated with accessing the second financial institution directly through a dedicated website of the second financial institution.

13. The machine readable medium of claim 9, wherein the first account information comprises at least transaction information that is categorizable by a user in the financial application module.

14. The machine readable medium of claim 9, wherein the account information of the first and second user accounts are continually updated via continuously communicating messages between the network device and the first server.

15. The machine readable medium of claim 9, further comprising providing a budgeting feature to the user using compiled first and second account information from one or more financial institutions.

16. The machine readable medium of claim 9, further comprising providing an analyzing feature configured to analyze user activities among one or more accounts of one or more financial institutions.

17. A computer system comprising:
a linking interface configured to allow communications between a server and a financial application module;
a memory;
a processor coupled to the linking interface and the memory, the processor operative to:
execute a financial application module implemented in the memory;
request first account information for a user from a first server of a subscribed first financial institution, the request communicated from the financial application module, wherein the request is sent from the linking interface as one or more messages in compliance with a standardized messaging scheme;
receive the first account information at the linking interface, the first account information transmitted from the first server of the subscribed first financial institution as one or more transmitted messages in compliance with the standardized messaging scheme;
compile the first account information from the first server; and
display the compiled first account information in the use interface.

18. The computer system of claim 17, wherein the processor is located in a server handled by a financial institution, wherein the server includes the financial application module and the linking interface.

19. The computer system of claim 18, wherein the processor is further comprised and operative to:
receive a user instruction via the user interface to obtain second account information from a second server of a subscribed second financial institution;
request the second account information from the financial application module, wherein the request is sent from the linking interface of the first server to a corresponding linking interface of the second server as one or more messages in compliance with a standardized messaging scheme;
receive the second account information at the linking interface of the first server from the second server of the subscribed second financial institution as one or more transmitted messages in compliance with the standardized messaging scheme;
compile the second account information on the first server; and
display the compiled second account information in the use interface.

20. The computer system of claim 17, wherein the processor is further comprised and operative to:
receive authentication information of the user to access the financial application module, wherein the authentication information is unique to the financial application module and is different than user authentication information associated with accessing the second financial institution directly through a dedicated website of the second financial institution.

21. The computer system of claim 17, wherein the first account information comprises at least transaction information that is categorizable by a user in the financial application module.

22. The computer system of claim 17, wherein the account information of the first and second user accounts are continually updated via continuously communicating messages between the network device and the first server.

23. The computer system of claim 17, further comprising a budgeting feature to the user using compiled first and second account information from one or more financial institutions.

24. The computer system of claim 17, further comprising an analyzing feature configured to analyze user activities among one or more accounts of one or more financial institutions.
